(19) United States
(12) Patent Application Publication
(10) Pub. No.: US 2025/0337946 A1
(43) Pub. Date: Oct. 30, 2025

(54) BI-DIRECTIONAL OPTICAL FLOW ON GPM WITH BI-PREDICTIVE MOTION VECTOR

(71) Applicant: Tencent America LLC, Palo Alto, CA (US)

(72) Inventors: Lien-fei CHEN, Palo Alto, CA (US); Xin ZHAO, San Jose, CA (US); Han GAO, San Diego, CA (US); Roman CHERNYAK, Santa Clara, CA (US); Xiaozhong XU, State College, PA (US); Shan LIU, San Jose, CA (US)

(73) Assignee: Tencent America LLC, Palo Alto, CA (US)

(21) Appl. No.: 19/262,006

(22) Filed: Jul. 7, 2025

Related U.S. Application Data
(63) Continuation of application No. PCT/US2024/025680, filed on Apr. 22, 2024.
(60) Provisional application No. 63/461,580, filed on Apr. 24, 2023.

(51) Int. Cl. H04N 19/513; H04N 19/105; H04N 19/139; H04N 19/176; H04N 19/543; H04N 19/577

(52) U.S. Cl. CPC H04N 19/521; H04N 19/105; H04N 19/139; H04N 19/176; H04N 19/543; H04N 19/577

(57) ABSTRACT

Some aspects of the disclosure provide an apparatus for video decoding. The apparatus includes processing circuitry configured to receive a coded video bitstream comprising coded information of one or more pictures, determine, from the coded information, that a current block in a current picture is in a geometric partition mode (GPM) with at least a first GPM partition having a bi-predictive motion vector, and apply subblock based motion refinements with bi-directional motion on at least a first subblock and a second subblock of the first GPM partition. The first subblock and the second subblock have different subblock sizes. The processing circuitry reconstructs the current block based on the subblock based motion refinements.

### RELATED APPLICATIONS

The present application is a continuation of International Application No. PCT/US2024/025680, entitled “BI-DIRECTIONAL OPTICAL FLOW ON GPM WITH BI-PREDICTIVE MOTION VECTOR” and filed on Apr. 22, 2024, which claims the benefit of priority to U.S. Provisional Application No. 63/461,580, entitled “BI-DIRECTIONAL OPTICAL FLOW ON GPM WITH BI-PREDICTIVE MOTION VECTOR” and filed on Apr. 24, 2023. The entire disclosures of the prior applications are hereby incorporated by reference.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

Some aspects of the disclosure provide a method of processing visual media data. The method includes processing a bitstream of visual media data according to a format rule. The bitstream includes coded information of one or more pictures that indicate a current block in a current picture is coded in a geometric partition mode (GPM) mode with at least a first GPM partition having a bi-predictive motion vector. The format rule specifies that the current block is split into GPM partitions according to the GPM mode, a first GPM partition of GPM partition has a bi-predictive motion vector, and the first GPM partition is divided into larger subblocks of a N×N size, N is a positive number and the N×N size is larger than or equal to a largest supported subblock size for a subblock based motion refinement. The format rule also specifies that respective subblock sizes for the larger subblocks of the N×N size are determined according to a blending mask for the current block, the larger subblocks are divided into subblocks based on the respective subblock sizes, and the subblock based motion refinement on a specific subblock is applied based on values of the blending mask in the specific subblock. The subblock based motion refinement is one of a bi-directional optical flow (BDOF) motion refinement and a decoder side motion vector refinement (DMVR) refinement.

Some aspects of the disclosure provide an apparatus for video decoding. The apparatus includes processing circuitry configured to receive a coded video bitstream comprising coded information of one or more pictures, determine, from the coded information, that a current block in a current picture is in a geometric partition mode (GPM) with at least a first GPM partition having a bi-predictive motion vector, and apply subblock based motion refinements with bi-directional motion on at least a first subblock and a second subblock of the first GPM partition. The first subblock and the second subblock have different subblock sizes. The processing circuitry reconstructs the current block based on the subblock based motion refinements.

In some examples, the subblock based motion refinements are bi-directional optical flow (BDOF) motion refinements, the first subblock is a first BDOF subblock, and the second subblock is a second BDOF subblock.

In some examples, the processing circuitry is configured to divide the first GPM partition into larger subblocks of a N×N size, N is a positive number and the N×N size is larger than or equal to a largest supported BDOF subblock size. The processing circuitry is further configured to determine respective BDOF subblock sizes for the larger subblocks of the N×N size, divide the larger subblocks into BDOF subblocks based on the respective BDOF subblock sizes, and apply the BDOF motion refinements on the BDOF subblocks.

In some examples, the processing circuitry is configured to determine a supported BDOF subblock size based on a size of the current block.

In some examples, the processing circuitry is configured to determine a first BDOF subblock size for a first larger subblock of the N×N size according to values of a blending mask in the first larger subblock, divide the first larger subblock into first BDOF subblocks according to the first BDOF subblock size and apply the BDOF motion refinements on the first BDOF subblocks.

In an example, the processing circuitry is configured to perform setting the first BDOF subblock size to be the largest supported BDOF subblock size when all of mask values in the first larger subblock correspond a maximum weight value or correspond to a minimum weight value. In an example, the processing circuitry is configured to perform setting the first BDOF subblock size to be smaller than the largest supported BDOF subblock size and larger or equal to a minimum supported BDOF subblock size when none of the mask values in the first larger subblock correspond to the maximum weight value. In an example, the processing circuitry is configured to perform setting the first BDOF subblock size to be smaller than the largest supported BDOF subblock size and larger or equal to the minimum supported BDOF subblock size when none of the mask values in the first larger subblock correspond to the minimum weight value. In an example, the processing circuitry is configured to perform setting the first BDOF subblock size to be smaller than the largest supported BDOF subblock size and larger or equal to the minimum supported BDOF subblock size when none of the mask values in the first larger subblock correspond to the maximum weight value or the minimum weight value.

In some examples, the processing circuitry is configured to determine whether to apply a BDOF refinement on at least a portion of the first larger subblock based on a mask value in the portion of the first larger subblock.

In some examples, the processing circuitry is configured to determine to apply the BDOF refinement on the portion of the first larger subblock when all of mask values in the portion of the first larger subblock correspond a maximum weight value or correspond to a minimum weight value, determine to apply the BDOF refinement on the portion of the first larger subblock when none of the mask values in the portion of the first larger subblock are zero, determine to apply the BDOF refinement on the portion of the first larger subblock when all of the mask values in the portion of the first larger subblock are higher than a threshold, and determine to apply the BDOF refinement on the portion of the first larger subblock when all of the mask values in the portion of the first larger subblock are smaller than a threshold.

In some examples, the subblock based motion refinements are decoder side motion vector refinement (DMVR) refinements, the first subblock is a first DMVR subblock, and the second subblock is a second DMVR subblock.

In some examples, the processing circuitry is configured to divide the first GPM partition into a plurality of subblocks, and determine whether to apply a DMVR refinement on a specific subblock based on mask values of a blending mask in the specific subblock.

In an example, the processing circuitry is configured to determine a supported DMVR subblock size based on a size of the current block.

In some examples, the processing circuitry is configured to determine to apply the DMVR refinement on the specific subblock when all of the mask values in the specific subblock correspond a maximum weight value or correspond to a minimum weight value.

In some examples, the processing circuitry is configured to apply a multi-pass DMVR on the specific subblock when the DMVR refinement is determined to be applied on the specific subblock. In an example, the processing circuitry is configured to determine to apply the multi-pass DMVR based on a GPM split mode index.

In an example, the processing circuitry is configured to determine to apply the multi-pass DMVR when a GPM angle is one of horizontal and/or vertical.

In some examples, the processing circuitry is configured to check whether a GPM partitioning boundary crosses a specific subblock, apply a subblock based motion refinement with bi-directional motion on the specific subblock when the GPM partitioning boundary does not cross the specific subblock, and disable the subblock based motion refinement for the specific subblock when the GPM partitioning boundary crosses the specific subblock.

Some aspects of the disclosure provide a method for video encoding. The method includes determining to use a GPM mode for a current block in a current picture, determining that a first GPM partition have a bi-predictive motion vector, and dividing the first GPM partition into larger subblocks of a N×N size, N is a positive number and the N×N size is larger than or equal to a largest supported subblock size for a subblock based motion refinement. The method further includes determining respective subblock sizes for the larger subblocks of the N×N size according to a blending mask for the current block, dividing the larger subblocks into subblocks based on the respective subblock sizes, and determining whether to apply the subblock based motion refinement on a specific subblock based on values of the blending mask in the specific subblock.

In some examples, the subblock based motion refinement is bi-directional optical flow (BDOF) motion refinement.

In some examples, the subblock based motion refinement is decoder side motion vector refinement (DMVR) refinements.

According to another aspect of the disclosure, an apparatus is provided. The apparatus includes processing circuitry. The processing circuitry can be configured to perform any of the described methods for video decoding/encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an exemplary block diagram of a communication system.

FIG. 2 is a schematic illustration of an exemplary block diagram of a decoder.

FIG. 3 is a schematic illustration of an exemplary block diagram of an encoder.

FIG. 4 shows positions of spatial merge candidates according to an embodiment of the disclosure.

FIG. 5 shows candidate pairs that are considered for a redundancy check of spatial merge candidates according to an embodiment of the disclosure.

FIG. 6 shows exemplary motion vector scaling for a temporal merge candidate.

FIG. 7 shows exemplary candidate positions for a temporal merge candidate of a current block.

FIG. 8 shows a diagram of angles that are used in the geometric partition mode (GPM) in some examples.

FIG. 9 shows a diagram of possible partition edges in an example.

FIG. 10 shows a diagram that illustrates the blending process in some examples.

FIG. 11 shows a diagram of a ramp function for the weights for GPM blending based on the displacement from a predicted sample position to the GPM partition boundary and the blending area size.

FIGS. 12A-12D show diagrams of GPM with inter and intra prediction in some examples.

FIG. 13 shows a diagram illustrating an extension of the GPM split edge to obtain the edge on template in some examples.

FIG. 14 shows an exemplary schematic view of a bilateral matching based decoder side motion vector refinement in some examples.

FIG. 15 shows a diagram illustrating some calculations in a bi-directional optical flow (BDOF) in an example.

FIG. 16 shows a search area in some examples.

FIG. 17 shows a flow chart outlining a decoding process according to some embodiments of the disclosure.

FIG. 18 shows a flow chart outlining an encoding process according to some embodiments of the disclosure.

FIG. 19 is a schematic illustration of a computer system in accordance with an embodiment.

### DETAILED DESCRIPTION OF EMBODIMENTS

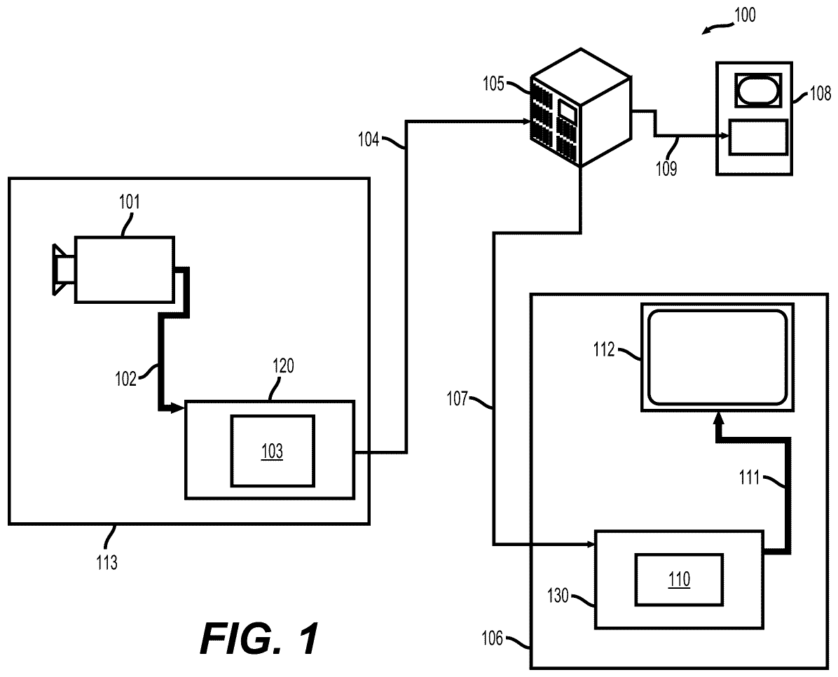

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

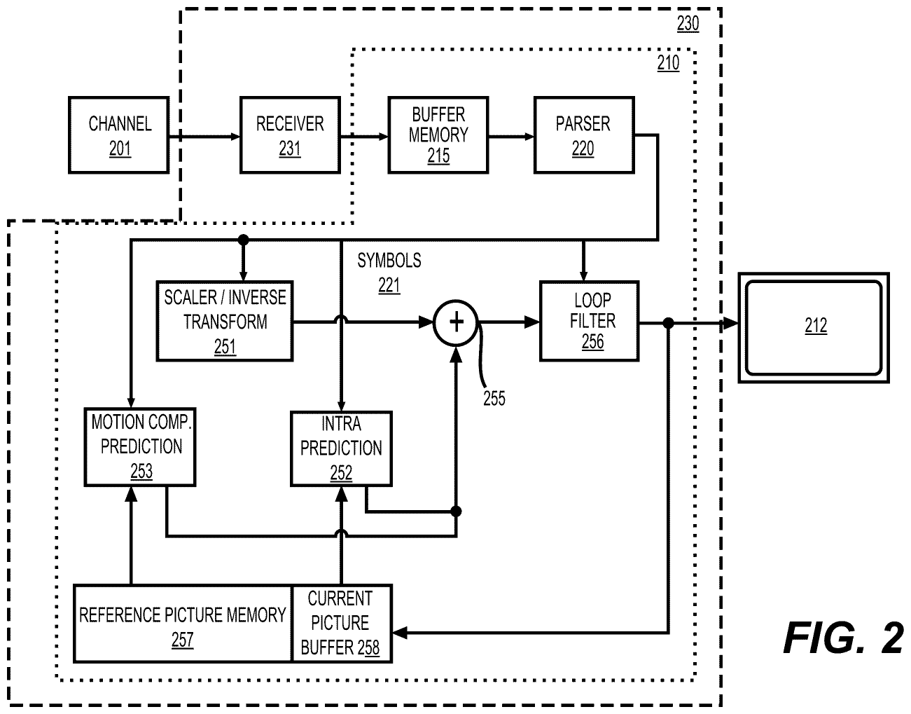

FIG. 2 shows an exemplary block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an embodiment, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that Is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (cUs), blocks, Transform Units (tUs), Prediction Units (pUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residua) signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

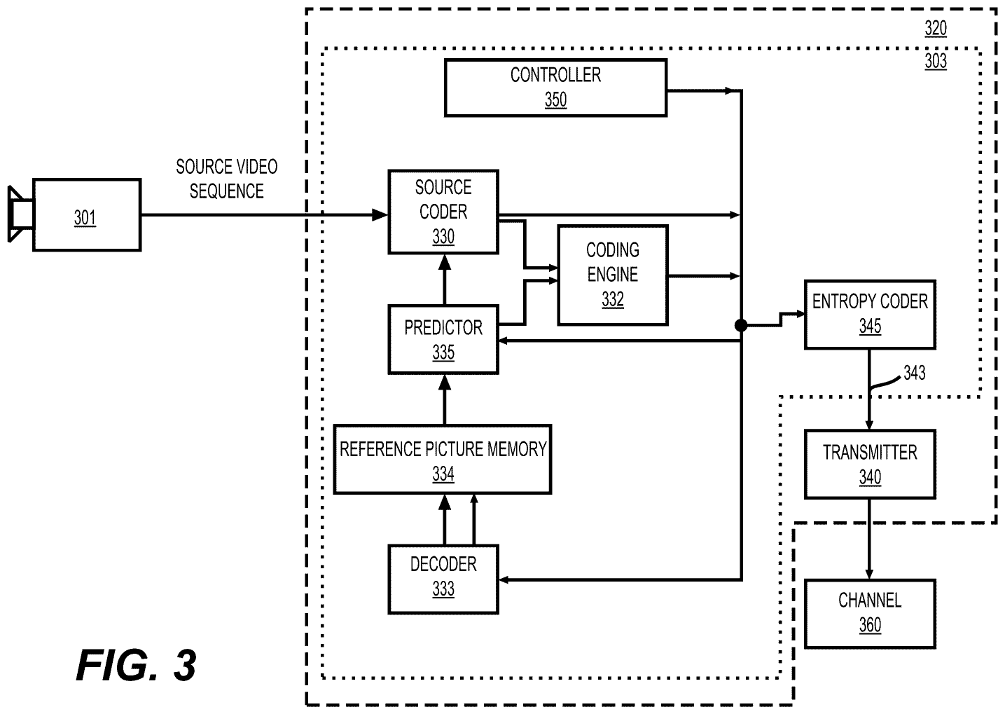

FIG. 3 shows an exemplary block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an embodiment, the video encoder (303) may code and compress the pictures of the source video sequence into a coded video sequence (343) in real time or under any other time constraints as required. Enforcing appropriate coding speed is one function of a controller (350). In some embodiments, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some embodiments, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder ““see”” as reference picture samples exactly the same sample values as a decoder would ““se”” when using prediction during decoding. This fundamental principle of reference picture synchronicity (and resulting drift, if synchronicity cannot be maintained, for example because of channel errors) is used in some related arts as well.

The operation of the ““loca”” decoder (333) can be the same as a ““remot”” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the block” respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an embodiment, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (cUs). For example, a CTU of 64×64 pixels can be split into one CU of 64×64 pixels, or 4 cUs of 32×32 pixels, or 16 cUs of 16×16 pixels. In an example, each CU is analyzed to determine a prediction type for the CU, such as an inter prediction type or an intra prediction type. The CU is split into one or more prediction units (pUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an embodiment, the video encoders (103) and (303) and the video decoders (110) and (210) can be implemented using one or more integrated circuits. In another embodiment, the video encoders (103) and (303), and the video decoders (110) and (210) can be implemented using one or more processors that execute software instructions.

Various inter prediction modes can be used in video coding. For example, in VVC, for an inter-predicted CU, motion parameters can include MV(s), one or more reference picture indices, a reference picture list usage index, and additional information for certain coding features to be used for inter-predicted sample generation. A motion parameter can be signaled explicitly or implicitly. When a CU is coded with a skip mode, the CU can be associated with a PU and can have no significant residual coefficients, no coded motion vector delta or MV difference (e.g., MVD) or a reference picture index. A merge mode can be specified where the motion parameters for the current CU are obtained from neighboring CU(s), including spatial and/or temporal candidates, and optionally additional information such as introduced in VVC. The merge mode can be applied to an inter-predicted CU, not only for skip mode. In an example, an alternative to the merge mode is the explicit transmission of motion parameters, where MV(s), a corresponding reference picture index for each reference picture list and a reference picture list usage flag and other information are signaled explicitly per CU.

In an embodiment, such as in VVC, VVC Test model (VTM) reference software includes one or more refined inter prediction coding tools that include: an extended merge prediction, a merge motion vector difference (MMVD) mode, an adaptive motion vector prediction (AMVP) mode with symmetric MVD signaling, an affine motion compensated prediction, a subblock-based temporal motion vector prediction (SbTMVP), an adaptive motion vector resolution (AMVR), a motion field storage ( 1/16^{th} luma sample MV storage and 8×8 motion field compression), a bi-prediction with CU-level weights (BCW), a bi-directional optical flow (BDOF), a prediction refinement using optical flow (PROF), a decoder side motion vector refinement (DMVR), a combined inter and intra prediction (CIIP), a geometric partitioning mode (GPM), and the like. Inter predictions and related methods are described in details below.

Extended merge prediction can be used in some examples. In an example, such as in VTM4, a merge candidate list is constructed by including the following five types of candidates in order: spatial motion vector predictor(s) (MVP(s)) from spatial neighboring CU(s), temporal MVP(s) from collocated CU(s), history-based MVP(s) (HMVP(s)) from a first-in-first-out (FIFO) table, pairwise average MVP(s), and zero MV(s).

A size of the merge candidate list can be signaled in a slice header. In an example, the maximum allowed size of the merge candidate list is 6 in VTM4. For each CU coded in the merge mode, an index (e.g., a merge index) of a best merge candidate can be encoded using truncated unary binarization (TU). The first bin of the merge index can be coded with context (e.g., context-adaptive binary arithmetic coding (CABAC)) and a bypass coding can be used for other bins.

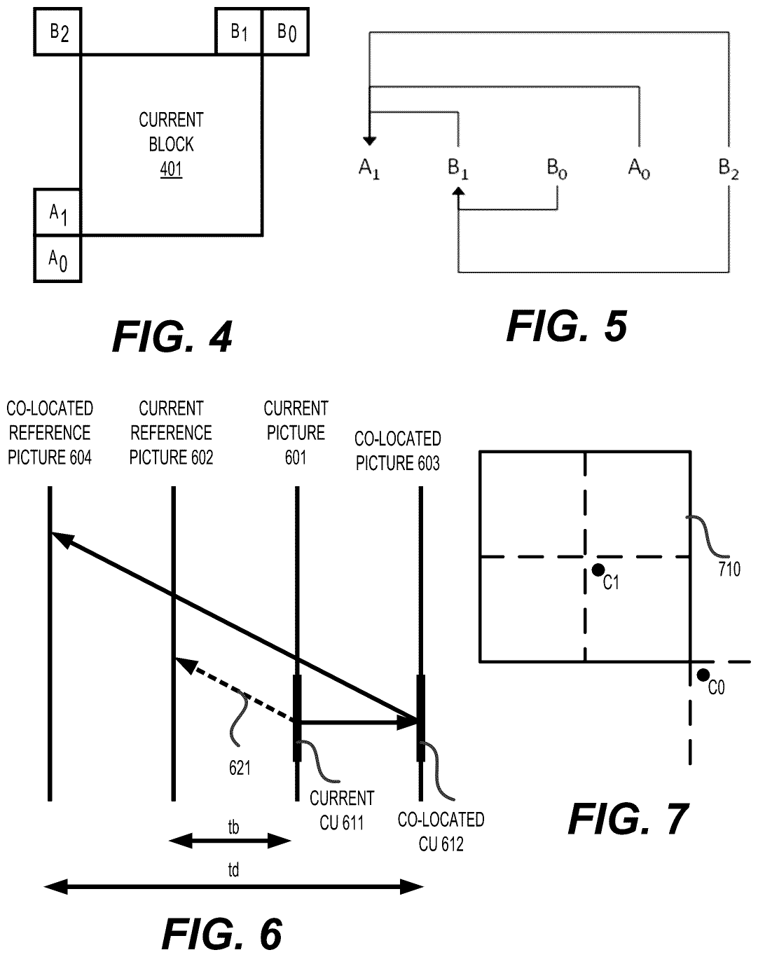

Some examples of a generation process of each category of merge candidates are provided below. In an embodiment, spatial candidate(s) are derived as follows. The derivation of spatial merge candidates in VVC can be identical to that in HEVC. In an example, a maximum of four merge candidates are selected among candidates located in positions depicted in FIG. 4.

FIG. 4 shows positions of spatial merge candidates according to an embodiment of the disclosure. Referring to FIG. 4, an order of derivation is B1, A1, B0, A0, and B2. The position B2 is considered only when any CU of positions A0, B0, B1, and A1 is not available (e.g., because the CU belongs to another slice or another tile) or is intra coded. After a candidate at the position A1 is added, the addition of the remaining candidates is subject to a redundancy check which ensures that candidates with same motion information are excluded from the candidate list so that coding efficiency is improved.

To reduce computational complexity, not all possible candidate pairs are considered in the mentioned redundancy check. Instead, only pairs linked with an arrow in FIG. 5 are considered and a candidate is only added to the candidate list if the corresponding candidate used for the redundancy check does not have the same motion information.

FIG. 5 shows candidate pairs that are considered for a redundancy check of spatial merge candidates according to an embodiment of the disclosure. Referring to FIG. 5, the pairs linked with respective arrows include A1 and B1, A1 and A0, A1 and B2, B1 and B0, and B1 and B2. Thus, candidates at the positions B1, A0, and/or B2 can be compared with the candidate at the position A1, and candidates at the positions B0 and/or B2 can be compared with the candidate at the position B1.

In an embodiment, temporal candidate(s) are derived as follows. In an example, only one temporal merge candidate is added to the candidate list. FIG. 6 shows exemplary motion vector scaling for a temporal merge candidate. To derive the temporal merge candidate of a current CU (611) in a current picture (601), a scaled MV (621) (e.g., shown by a dotted line in FIG. 6) can be derived based on a co-located CU (612) belonging to a collocated reference picture) 604). A reference picture list used to derive the co-located CU (612) can be explicitly signaled in a slice header. The scaled MV (621) for the temporal merge candidate can be obtained as shown by the dotted line in FIG. 6. The scaled MV (621) can be scaled from the MV of the co-located CU (612) using picture order count (POC) distances tb and td. The POC distance tb can be defined to be the POC difference between a current reference picture (602) of the current picture (601) and the current picture (601). The POC distance td can be defined to be the POC difference between the collocated reference picture (604) of the co-located picture (603) and the co-located picture (603). A reference picture index of the temporal merge candidate can be set to zero. The collocated picture is a reference picture that is used as the source picture for temporal motion information derivation. The collocated picture can be identified in one of two lists, referred to as list0 or list1. In some examples, the encoder can determine the collocated picture and signal the collocated picture using suitable syntax techniques.

FIG. 7 shows exemplary candidate positions (e.g., C0 and C1) for a temporal merge candidate of a current CU. A position for the temporal merge candidate can be selected from the candidate positions C0 and C1. The candidate position C0 is located at a bottom-right corner of a co-located CU (710) of the current CU. The candidate position C1 is located at a center of the co-located CU (710) of the current CU. If a CU at the candidate position C0 is not available, is intra coded, or is outside of a current row of CTUs, the candidate position C1 is used to derive the temporal merge candidate. Otherwise, for example, the CU at the candidate position C0 is available, inter coded, and in the current row of CTUs, the candidate position C0 is used to derive the temporal merge candidate. A temporal merge candidate can specify the motion information of a temporal motion vector predictor (TMVP).

In some examples (e.g., VVC), a technique that is referred to as geometric partition mode (GPM) is used. Specifically, in VVC, GPM is used for inter prediction. In an example, the GPM is only applied to cUs that are 8×8 or larger. The GPM can be signaled using a CU-level flag as one kind of merge modes, with other merge modes, such as a regular merge mode, a merge with motion vector difference (MMVD) mode, a combined inter and intra prediction (CIIP) mode and a subblock merge mode.

When the GPM mode is used on a CU, the CU is split by a partition edge into two geometric-shaped partitions using one of a plurality of partitioning manners. In some examples, 64 different partitioning manners are used. The partitioning manners can be differentiated by 24 angles (non-uniformed quantized between 0 and 360°) and up to 4 edges relative to the center of the CU for each angle. The partition edge is a line that intersects boundaries of the CU and splits the CU into two partitions.

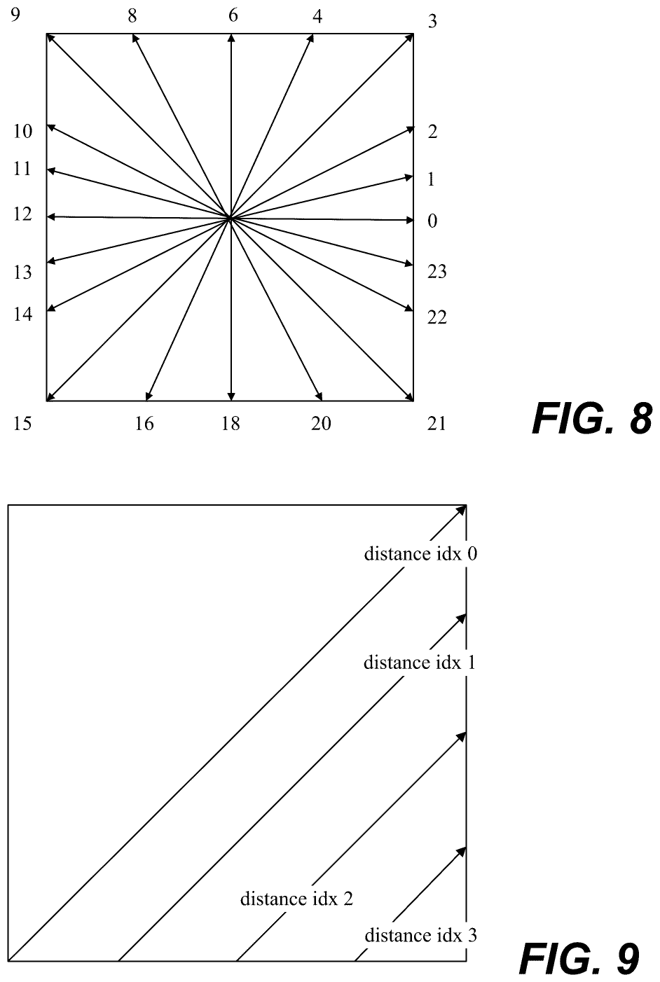

FIG. 8 shows a diagram of 24 angles that are used in the GPM in some examples. The angles can be identified using angle indices, such as angle index 0 to angle index 23 in some examples.

FIG. 9 shows a diagram of possible partition edges for the angle index 3 in an example. In FIG. 9, four possible partition edges can be associated with the angle index 3. It is noted that, for some angle indices, three possible partition edges may be associated with each angle index.

In some examples, each geometric partition in the CU is inter-predicted using its own motion. In an example, only uni-prediction is allowed for each partition, that is, each partition has one motion vector and one reference picture index. The uni-prediction motion constraint is applied to ensure that, similar to bi-prediction, two motion compensated predictions are needed for each CU.

In some examples, when the GPM is used for the current CU, then a signal indicating the geometric partition index (e.g., indicating an angle and an edge), and two merge indices (one for each partition) are further signalled. In an example, the number of maximum GPM candidate size is signalled explicitly at slice level and specifies syntax binarization for GPM merge indices.

In some examples, after predicting each of these two geometric partitions, the sample values along the geometric partition edge are adjusted using a blending process with adaptive weights.

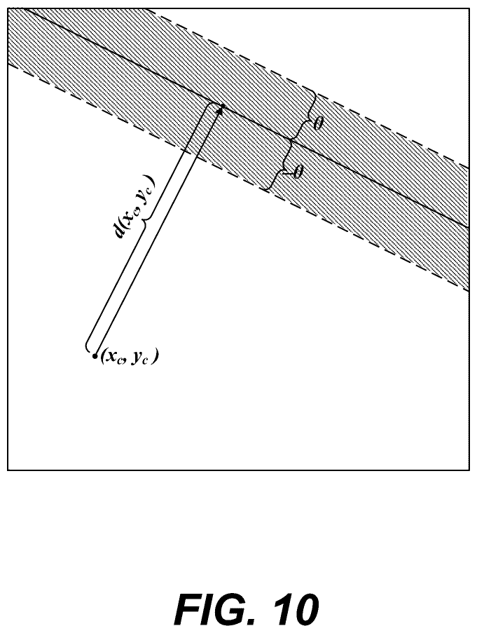

FIG. 10 shows a diagram that illustrates the blending process in some examples. The blending process uses a parameter that is referred to as a blending strength or blending area width θ of GPM. The blending strength θ can be fixed for all different contents.

In some examples, weighing values in a blending mask for the blending process can be given by a ramp function, such as according to Eq. (1)

$${ω}_{{x}_{c} , {y}_{c}} = \{ \begin{matrix}0 & d ( {x}_{c} , {y}_{c} ) \leq - θ \\ \frac{8}{2 θ} ( d ( {x}_{c} , {y}_{c} ) + θ ) & - θ < d ( {x}_{c} , {y}_{c} ) < θ \\ 8 & d ( {x}_{c} , {y}_{c} ) \geq θ\end{matrix} , \qquad Eq . ( 1 )$$

In an example, with a fixed θ=2 pel, the ramp function can be quantized as Eq. (2):

$${ω}_{m , n} = Clip 3 ( 0 , 8 , ( d ( m , n ) + 32 + 4 ) >> 3 ) \qquad Eq . ( 2 )$$

The result of the blending process is used as the prediction signal for the whole CU, and transform and quantization process can be further applied to the whole CU in a similar manner as in other prediction modes. Finally, the motion field (e.g., motion information) of the CU predicted using the GPM is stored. In some examples (e.g., VVC), the motion information of a CU is stored in 4×4 unit (e.g., for every 4×4 luma samples). The stored motion information is used for the MV prediction and merge list construction for next coded CU. In GPM, three types of motion information are spanned and stored in 4×4 unit. The three types of motion information may include motion information of the two partitions, and motion information of the blending area. For example, two geometric partitions, P₀ and P₁, include their own unidirectional MV and the blending area between P₀ and P₁ is predicted by motion information from the two geometric partitions, P₀ and P₁. Therefore, the motion information of GPM is stored according to the partitions.

The motion information of GPM is signaled at merge mode. In order to avoid additional memory bandwidth access, only uni-prediction is allowed for each partition in the GPM. In some examples, the regular merge candidates may be a uni-prediction or bi-prediction and cannot be directly used as GPM merge list. In order to minimize the implementation complexity, an index parity-based method can be used to directly extract the GPM merge candidates from the regular merge list without pruning. For example, for a candidate with an even value of the GPM merge index, the MV0 from reference list 0 with its corresponding regular merge index is used as the GPM merge candidate. If MV0 is not available, MV1 from reference list 1 is used instead. Conversely, MV1 is chosen as the default GPM merge candidate for the odd value of the GPM merge index.

According to some aspects of the disclosure, additional techniques of GPM are developed beyond VVC.

In some examples, a technique that is referred to as geometric partitioning mode (GPM) with merge motion vector differences (MMVD) can be used, the technique is also referred to as GPM-MMVD. The GPM in VVC is extended by applying motion vector refinement on top of the existing GPM uni-directional MVs. For example, a flag is first signaled for a CU of GPM to specify whether the GPM mode is used. When the mode GPM is used, each geometric partition of the CU in GPM can have a decision whether to signal MVD or not. When MVD is signaled for a geometric partition, after a GPM merge candidate is selected, the motion of the partition is further refined using the signaled MVDs information. All other procedures are kept the same as in GPM.

In some examples, the MVD in the GPM is signaled as a pair of distance and direction, similar as in MMVD. In an example, there are nine candidate distances, such as (¼-pel, ½-pel, 1-pel, 2-pel, 3-pel, 4-pel, 6-pel, 8-pel, 16-pel), and eight candidate directions (e.g., four horizontal/vertical directions and four diagonal directions) involved in GPM with MMVD (GPM-MMVD). In addition, in an example, when a flag (e.g., pic_fpel_mmvd_enabled_flag) is equal to 1, the MVD is left shifted by 2 as in MMVD.

In some examples, a technique that is referred to as geometric partitioning mode (GPM) with adaptive blending is used. In some examples (e.g., VVC), the final prediction samples are generated by blending the prediction of the two prediction signals using weighted average. Two integer blending matrices (W0 and W1) are used. In some examples, the weights in the GPM blending matrices are derived from a ramp function based on the displacement from a predicted sample position to the GPM partitioning boundary. In an example, the blending area size is fixed to two (e.g., 2 samples on each side of the GPM partition split boundary).

In some examples, the blending process is improved by adding extra blending area sizes, such as adding four blending area sizes that are quarter, half, double, and quadrupole of the existing area size.

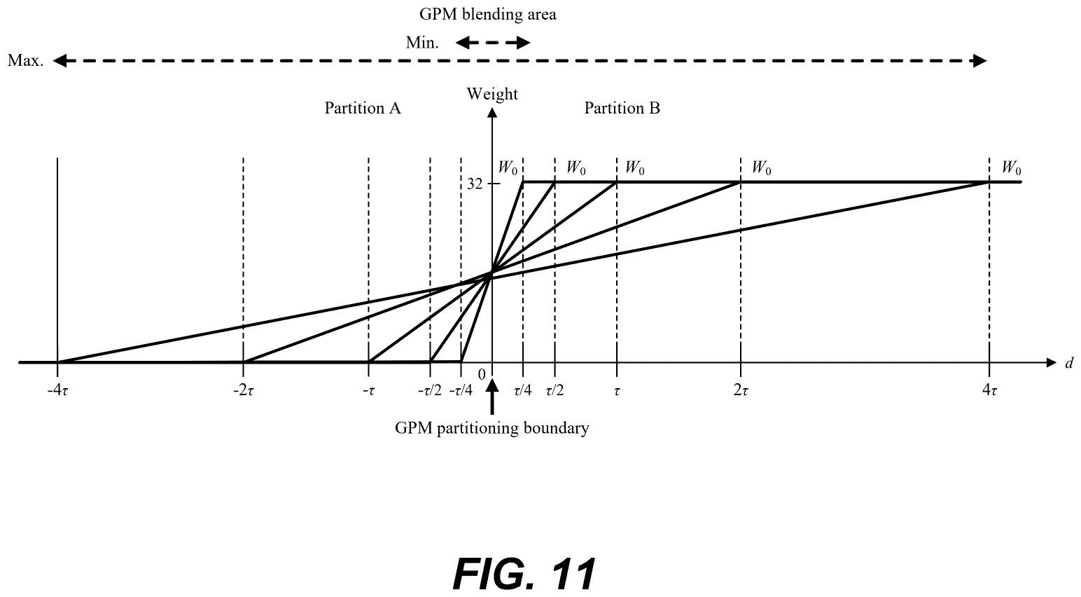

FIG. 11 shows a diagram of a ramp function for the weights for GPM blending based on the displacement (d) from a predicted sample position to the GPM partition boundary and the blending area size (r). In the FIG. 11 example, a first curve (1110) corresponds to a ramp function of a regular blending area (also referred to as existing area size), such as 2 samples on each side of the GPM partition split boundary; a second curve (1120) corresponds to a ramp function of quarter blending area of the regular blending area; a third curve (1130) corresponds to a ramp function of half blending area of the regular blending area; a fourth curve (1140) corresponds to a ramp function of double blending area of the regular blending area; a fifth curve (1150) corresponds to a ramp function of quadrupole blending area of the regular blending area.

In some examples, a CU level flag is coded to signal the selected blending area size. Furthermore, the extended weighting precision can be utilized, in which the maximum value of the weighs is changed from 8 (in VVC) to 32 to accommodate the extended blending area sizes.

In some examples, in order to accommodate the increased width of the GPM blending area, the maximum value of the weighs is changed from 8 to 32. In an example, the weights are calculated as Eq. (3):

$${ω}_{{x}_{c} , {y}_{c}} = \{ \begin{matrix}Clip ( 0 , 32 , ( d ( m , n ) + 16 θ + ( θ >> 1 ) ) >> {log}_{2} θ ) & θ \geq 1 \\ Clip ( 0 , 32 , ( d ( m , n ) + 16 θ + ( θ >> 1 ) ) << {log}_{2} θ ) & θ < 1 \\ d ( m , n ) > 0 ? 32 : 0 & θ = θ\end{matrix} \qquad Eq . ( 3 )$$

The width of the blending area (e.g., τ=2θ) is allowed to be selected from a set of pre-defined values. The pre-defined value θ can be {½, 1, 2, 4, 8} in an example.

In some examples, a technique that is referred to as geometric partitioning mode (GPM) with template matchingI) is used, the technique is referred to as GPM-TM in an example.

In some examples, to apply template matching to GPM, when GPM mode is enabled for a CU, a CU-level flag is signaled to indicate whether TM is applied to both geometric partitions. Motion information for each geometric partition can be refined using TM. When TM is chosen, a template is constructed using left, above or left and above neighboring samples according to a partition angle.

Table 1 shows template for the first and second geometric partitions.

TABLE 1

| Partition angle | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

In Table 1, A denotes using the above samples, L denotes using left samples, and L+A denotes using both left and above samples.

In some examples, the motion information is then refined by minimizing the difference between the current template and the template in the reference picture using the same search pattern of merge mode with half-pel interpolation filter disabled.

In some examples, a GPM candidate list can be constructed. For example, in a first step, interleaved List-0 MV candidates and List-1 MV candidates are derived directly from the regular merge candidate list, where List-0 MV candidates have higher priority than List-1 MV candidates. A pruning method with an adaptive threshold based on the current CU size is applied to remove redundant MV candidates. In a second step, interleaved List-1 MV candidates and List-0 MV candidates are further derived directly from the regular merge candidate list, where List-1 MV candidates have higher priority than List-0 MV candidates. The same pruning method with the adaptive threshold is also applied to remove redundant MV candidates. In a third step, zero MV candidates are padded until the GPM candidate list is full.

In some examples, the GPM-MMVD and GPM-TM are exclusively enabled to one GPM CU. In an example, a signaling of the GPM-MMVD syntax is firstly performed. When both two GPM-MMVD control flags are equal to false (e.g., the GPM-MMVD are disabled for both of the two GPM partitions), the GPM-TM flag is signaled to indicate whether the template matching is applied to the two GPM partitions. Otherwise (e.g., at least one GPM-MMVD flag is equal to true), the value of the GPM-TM flag is inferred to be false.

In some examples, a technique that is referred to as GPM with inter and intra prediction is used. In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is pre-defined as 3.

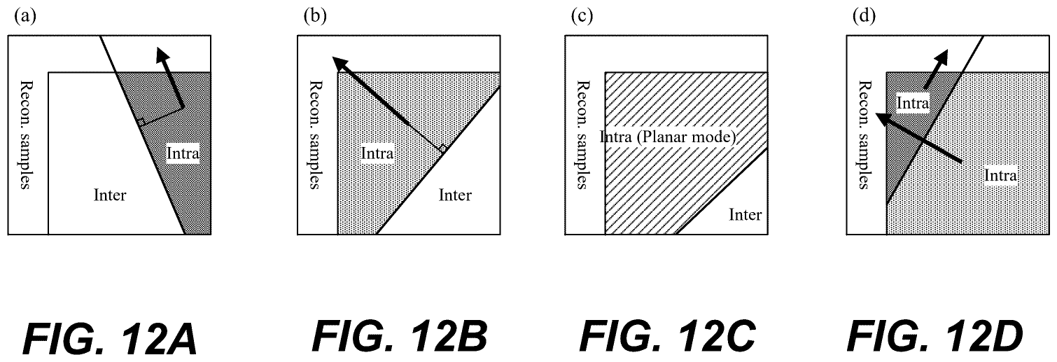

FIGS. 12A-12D show diagrams of GPM with inter and intra prediction in some examples. FIGS. 12A-12C show diagram of available IPM candidates. FIG. 12A shows a diagram of parallel angular mode against the GPM block boundary (e.g., partitioning boundary) (parallel mode); FIG. 12B shows a diagram of perpendicular angular mode against the GPM block boundary (e.g., partitioning boundary) (perpendicular mode); and FIG. 12C shows a diagram of a planar mode. FIG. 12D shows a diagram of GPM with intra and intra prediction. In some examples, the GPM with intra and intra prediction is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In some examples, in decoder side intra mode derivation (DIMD) and neighboring mode based IPM derivation parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 2, which are already used for GPM with template matching (GPM-TM).

Table 2 shows position of available neighboring blocks for IPM candidate derivation based on the angle of GPM block boundary.

TABLE 2

| Angle of GPM | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

In Table 2, A denotes the above side of the prediction block, L denotes the left side of the prediction block, L+A denotes left and the above side of the prediction block.

In some examples, a technique that is referred to as template matching based reordering for GPM split modes can be used.

Generally, template match (TM) is used to refine the motion at the decoder side. In TM mode, motion is refined by constructing a template from the left and/or the above neighboring reconstructed samples and finding the closest matching between the template in the current picture and the reference frame.

Template matching can be applied to GPM. When a CU is coded in GPM, decisions whether to refine using TM or not can be made on motion for each geometric partition. When TM is chosen, a template is constructed using left and/or above neighboring samples, and then the motion is refined by finding the best matching between the current template and a reference area with the same template pattern in the reference frame. The refined motion is used to perform motion compensation for the geometric partition and is stored in the motion field.

In some examples, in order to reduce the signaling cost of the GPM split mode index, the reordering of the GPM split mode indexes by using the template matching cost can be used. The reordering method for GPM split modes is a two-step process performed after the respective reference templates of the two GPM partitions in a coding unit are generated. For example, a first step can blend the reference templates of the two GPM partitions using the respective weights of split modes (e.g., resulting in 64 blended reference templates) and compute the TM cost value for each of the blended reference templates; a second step can reorder GPM split modes based on their TM cost values in ascending order and mark the best 32 as available split modes.

In some examples, the edge on the template can be obtained by extending from the (GPM split) edge of the current CU.

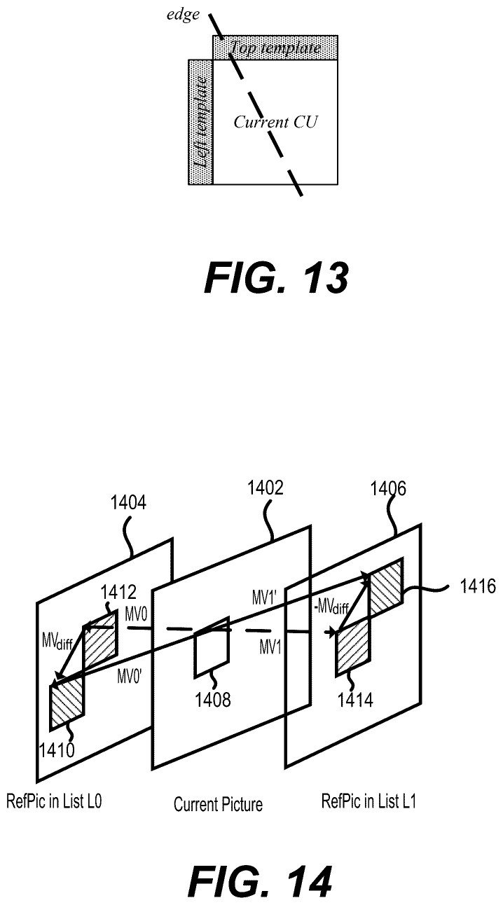

FIG. 13 shows a diagram illustrating an extension of the GPM split edge to obtain the edge on template in some examples. The corresponding weights used in the blending process of templates are computed using the same GPM weight derivation process, except that the weights are mapped to 0 and 8 before use depending on whichever is closer.

In some examples, after ascending reordering using TM cost, an index is signaled using Golomb-Rice code (with divisor 4) to indicate the use of GPM split mode.

In some examples, a technique that is referred to as GPM with bi-predictive motion vector is used. In some examples (e.g., ECM), the GPM relies on uni-predictive motion vectors to generate motion compensated prediction samples for each inter partition. In some examples, usage of bi-predictive motion vectors in the GPM is allowed. Furthermore, GPM-MMVD and GPM-TM are modified to incorporate the usage of bi-predictive motion vectors. The GPM with bi-predictive motion vector can include certain elements, such as following four elements in some examples.

The first element conditionally invokes the extraction process that extracts uni-predictive motion vectors from the initial list. In an example, the extraction process is invoked only for small blocks, such as 8×8, 16×8 and 8×16. For other larger blocks, the extraction process is bypassed in an example. The generation of the initial list is the same as before (i.e., the normal merge list generation without any candidate reordering) except that when generating the initial list for larger blocks (i.e., blocks with the extraction process bypassed), the motion vector difference threshold for controlling whether a candidate can be added into the initial list is increased to be one full sample distance.

The second element modifies GPM-MMVD to support bi-predictive motion vector as the base vector. For low-delay pictures, the signaled MVD is applied on top of the L0 and L1 motion vector as in the existing merge MMVD design. For non-low-delay pictures, the bi-predictive motion vector is converted into a uni-predictive motion vector first and then the MVD is applied on top.

The third element modifies GPM-TM to also support bi-predictive motion vectors. When the picture is a non-low-delay picture and the best template cost from using bi-prediction exceeds 75% of the best template cost from using uni-prediction, the refined uni-predictive motion vector is then determined to be the final refined motion vector. Otherwise, the refined bi-predictive motion vectors are determined to be the final refined motion vectors.

The fourth element is to enable 8×8 BDOF (i.e., as in the existing design of multi-pass DMVR) on top of the associated bi-predictive motion vectors for each inter partition.

In the inter-picture prediction, a merge mode can be used to improve coding efficiency. In the merge mode, the motion vector can be derived from neighboring blocks and is directly used for motion compensation. In order to increase the accuracy of the MVs of the merge mode, a bilateral-matching (BM)-based decoder side motion vector refinement (DMVR) can be applied, such as in VVC. In a bi-prediction operation, a refined MV can be searched around initial MVs in a reference picture list L0 and a reference picture list L1. The BM calculates a distortion between two candidate blocks in the reference picture list L0 and list L1.

FIG. 14 shows an exemplary schematic view of a BM-based decoder side motion vector refinement in some examples. As show in FIG. 14, a current picture (1402) can include a current block (1408). The current picture can have a first reference picture (1404) from (reference picture) list L0 and a second reference picture (1406) from (reference picture) list L1. For the current block (1408), according to initial motion vectors MV0 and MV1, a pair of reference blocks are identified in the first and second reference pictures. For example, an initial reference block (1412) in the first reference picture (1404) can be located according to the initial motion vector MV0 and an initial reference block (1414) in the second picture (1406) can be located according to an initial motion vector MV1. A searching process can be performed around the initial MV0 in the first reference picture (1404) and the initial MV1 in the second reference picture (1406). For example, an adjustment MVdiff is applied to the initial MV0 and MV1 in the opposite direction to obtain MV candidate, such as MV0′ and MV1′. According to the MV candidate, a pair of candidate reference blocks are identified in the first and second reference picture. For example, a candidate reference block (1410) can be identified in the first reference picture (1404) according to MV0′ and a candidate reference block (1416) can be identified in the second reference picture (1406) according to MV1′. In some examples, bilateral matching (BM) refers to an operation that calculates a distortion measure between a pair of reference blocks of respective reference pictures for the current picture, such as a sum of absolute differences (SAD) between a pair of reference blocks as the distortion measure of the pair of reference blocks. For example, BM method calculates an initial SAD between the pair of initial reference blocks (1412) and (1414), and calculates a second SAD between the pair of candidate reference blocks (1410) and (1416). The initial SAD is associated with the initial MV (e.g., MV0 and MV1), the second SAD is associated with the MV candidate (e.g., MV0′ and MV1′). Similarly, BM method can calculate SADs for a plurality of MV candidates around the initial MV. An MV candidate with the lowest SAD can become the refined MV and used to generate a bi-predicted signal to predict the current block (1408).

In some examples (e.g., VVC), the application of DMVR is restricted and is only applied for the CUs which are coded with modes and features that satisfy certain conditions. If a block satisfies certain conditions, the DMVR algorithm is invoked. For example, the conditions (also referred to as requirement for DMVR or a set of conditions for DMVR) can include: (1) CU level merge mode with bi-prediction MV; (2) One reference picture is in the past and another reference picture is in the future with respect to the current picture; (3) The distances (e.g., POC difference) from two reference pictures to the current picture are the same; (4) Both reference pictures are short-term reference pictures; (5) CU has more than 64 luma samples; (6) Both CU height and CU width are larger than or equal to 8 luma samples; (7) Bi-prediction with CU level weights (BCW) weight index indicates equal weight; (8) weighted prediction (WP) is not enabled for the current block; and (9) Combined inter and intra prediction (CIIP) mode is not used for the current block.

It is noted that the refined MV derived by DMVR process is used to generate the inter prediction samples and can be used in temporal motion vector prediction for future pictures coding. In some examples, the original MV is used in a deblocking process and also used in spatial motion vector prediction for future CU coding.

In DVMR, the search points are surrounding the initial MV and the MV offset obey the MV difference mirroring rule. Any points that are checked by DMVR, denoted by candidate MV pair (MV0′, MV1′) obey MV0′=MV0+MV_offset and MV1′=MV1−MV_offset. Where MV_offset represents the refinement offset between the initial MV (e.g., (MV0, MV1) and the refined MV in one of the reference pictures. The refinement search range is two integer luma samples from the initial MV in some examples. The searching includes the integer sample offset search stage and fractional sample refinement stage.

In some examples (e.g., VVC), decoder side motion vector refinement (DMVR) is applied to CU coded in regular merge mode. The pair of MVs obtained from the regular merge candidate is used as input of the DMVR process. DMVR applies the bilateral matching (BM) to refine the input MV pair {MV0, MV1} and uses the refined MV pair {MVrefinedL0, MVrefinedL1} for the motion compensated prediction of both luma and chroma components as shown in FIG. 4. The output MVs of DMVR can be referred to as refined MV pair, and can be represented by Eq. (4):

$$M {V}_{refinedL 0} = M V 0 + Δ m v \qquad Eq . ( 4 )$$

$$M {V}_{refinedL 1} = M V 1 - Δ m v$$

The motion vector difference Amy is applied to the input MV pair to obtain the refined MV pair by using the MVD mirroring property, because the input MV pair point to two different reference pictures that have equal difference in picture order count (POC) to the current picture and these two reference pictures are at different temporal direction.

In some examples, DMVR can be applied at subblock level, a luma coded block is divided into 16×16 subblocks for the MV refinement process. The Amy is derived independently for each of the subblocks.

In some examples, the motion vector refinement search range is two integer luma samples from the initial MV. The search for the motion vector can be performed in two steps, such as a first step of an integer sample offset search stage (also referred to as an integer precision motion search) and a second step of a fractional sample refinement stage (also referred to as a fractional motion search step or a fractional sample offset search).

In some examples, 25 points full search can be applied for integer sample offset searching, such as shown by Eq. (5):

$$m {v}_{L 0 ( i , j )} = m {v}_{L 0 ( 0 , 0 )} + ( i , j ) \qquad Eq . ( 5 )$$

$$m {v}_{L 1 ( i , j )} = m {v}_{L 1 ( 0 , 0 )} - ( i , j )$$

where (i, j) represents the coordinate of the search point around the initial MV pair, and i and j are integer value between −2 and 2 inclusive. The SAD of the initial MV pair is first calculated, such as according to Eq. (6):

$$SAD ( i , j ) = K {\sum }_{n = 0}^{\frac{H}{2}} {\sum }_{m = 0}^{W} {diff}_{m , n} \qquad Eq . ( 6 )$$

$${diff}_{m , n} = abs ( P {0}_{i , j} [ m + i , 2 n + j ] - P {1}_{i , j} [ m - i , 2 n - j ] and$$

$$K = \{ \begin{matrix}3 / 4 & i = 0 , j = 0 \\ 1 & otherwise\end{matrix}$$

where W and H are the weight and height of the subblock.

If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, the original MV (e.g., initial MV candidate MV0 and MV1) can be preferred during the DMVR process. The SAD between the reference blocks referred by the initial MV candidate is decreased, for example, by ¼ of the SAD value in order to make the initial MV candidate to be preferred.

In some examples, the integer sample search is followed by fractional sample refinement. In some examples, the fractional sample refinement is performed by using fractional sample offset, such as using ½ pel offset in vertical direction and horizontal direction, and the like. In some examples, to save the calculational complexity, the fractional sample refinement is derived by using parametric error surface equation (also referred to as quadratic prediction based method), instead of additional search with SAD comparison. The fractional sample refinement is conditionally invoked based on the output of the integer sample search stage. For example, when the integer sample search stage is terminated with specific integer position (also referred to as center) having the smallest SAD in either the first iteration or the second iteration search, the fractional sample refinement is further applied.

In parametric error surface based sub-pixel offsets estimation, the center position cost (the center position is the point with the smallest SAD in the integer sample offset searching) and the costs at four neighboring positions (e.g., (−1, 0), (0,−1), (1,0), (0,1) from the center position) from the center are used to fit a 2-D parabolic error surface equation, such as Eq. (7)

$$E ( x , y ) = {A ( x - {x}_{min} )}^{2} + {B ( y - {y}_{min} )}^{2} + C \qquad Eq . ( 7 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed according to Eq. (8) and Eq. (9):

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad Eq . ( 8 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad Eq . ( 9 )$$

The values of xₘᵢₙ and yₘᵢₙ can be automatically constrained to be—between—8 and 8 since all cost values are positive and the smallest value is E(0,0). The constraints correspond to half pel offset with 1/16-th-pel MV accuracy in VVC. The computed fractional (xₘᵢₙ, yₘᵢₙ) are added to the integer distance refinement MV to get the sub-pixel accurate refinement delta MV. In Eq. (3) and Eq. (4), E(−1,0), E(1,0), E(1,0), E(0, −1) and E(0,0) denote the cost values at the 5 points (the center position and four neighboring positions).

A technique that is referred to as bi-directional optical flow (BDOF) can be used for example in VVC. BDOF was previously referred to as BIO in the JEM. Compared to the JEM version, the BDOF in VVC can be a simpler version that requires less computation, especially in terms of the number of multiplications and the size of the multiplier.

BDOF can be used to refine a bi-prediction signal of a CU at a 4×4 subblock level. BDOF can be applied to a CU if the CU satisfies conditions (also referred to as requirement for BDOF, or a set of conditions for BDOF) as follows: (1) The CU is coded using “true” bi-prediction mode, i.e., one of the two reference pictures is prior to the current picture in display order and the other is after the current picture in display order; (2) The distances (e.g., POC difference) from two reference pictures to the current picture are the same; Both reference pictures are short-term reference pictures; The CU is not coded using affine mode or the SbTMVP merge mode; (5) CU has more than 64 luma samples; (6) Both CU height and CU width are larger than or equal to 8 luma samples; (7) BCW weight index indicates equal weight; (8) Weighted prediction (WP) is not enabled for the current CU; and (9) CIIP mode is not used for the current CU.

In some examples, BDOF is only applied to a luma component. As the name of BDOF indicates, the BDOF mode can be based on an optical flow concept, which assumes that a motion of an object is smooth. For each 4×4 subblock, a motion refinement (vₓ, v_{y}) can be calculated by minimizing a difference between L0 and L1 prediction samples. The motion refinement can then be used to adjust the bi-predicted sample values in the 4×4 subblock. BDOF can include steps as follows.

First, horizontal and vertical gradients,

$$\frac{\partial {I}^{( k )}}{\partial x} ( i , j ) and \frac{\partial {I}^{( k )}}{\partial y} ( i , j ) , k = 0 , 1 ,$$

of the two prediction signals from the reference list L0 and the reference list L1 can be computed by directly calculating a difference between two neighboring samples. The horizontal and vertical gradients can be provided in Eq. (10) and Eq. (11) as follows:

$$\frac{\partial {I}^{( k )}}{\partial x} ( i , j ) = ( ( {I}^{( k )} ( ) + 1 , j ) ≫ shift 1 ) - ( {I}^{( k )} ( ) - 1 , j ) ≫ shift 1 \qquad Eq . ( 10 )$$

$$\frac{\partial {I}^{( k )}}{\partial y} ( i , j ) = ( ( {I}^{( k )} ( ) , j + 1 ) ≫ shift 1 ) - ( {I}^{( k )} ( ) , j - 1 ) ≫ shift 1 \qquad Eq . ( 11 )$$

where I^{(k)}(i,j) can be a sample value at coordinate (i, j) of the prediction signal in list k, k=0,1, and shift1 can be calculated based on a luma bit depth, bitDepth, as shift1=max(6, bitDepth−6).

Then, auto- and cross-correlation of the gradients, S₁, S₂, S₃, S₅ and S₆, can be calculated according to Eqs. (12)-(16) as follows:

$${S}_{1} = {\sum }_{( i , j ) ∈ Ω} Abs ( {ψ}_{x} ( i , j ) ) \qquad Eq . ( 12 )$$

$${S}_{2} = {\sum }_{( i , j ) ∈ Ω} {ψ}_{x} ( i , j ) \cdot Sign ( {ψ}_{y} ( i , j ) ) \qquad Eq . ( 13 )$$

$${S}_{3} = {\sum }_{( i , j ) ∈ Ω} θ ( i , j ) \cdot Sign ( {ψ}_{x} ( i , j ) ) \qquad Eq . ( 14 )$$

$${S}_{5} = {\sum }_{( i , j ) ∈ Ω} Abs ( {ψ}_{y} ( i , j ) ) \qquad Eq . ( 15 )$$

$${S}_{6} = {\sum }_{( i , j ) ∈ Ω} θ ( i , j ) \cdot Sign ( {ψ}_{y} ( i , j ) ) \qquad Eq . ( 16 )$$

where ψₓ(i, j), ψ_{y}(i,j), and θ(i,j) can be provided in Eqs. (17)-(19) respectively.

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad Eq . ( 17 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \qquad Eq . ( 18 )$$

$$θ ( i , j ) = ( {I}^{( 1 )} ( i , j ) ≫ {n}_{b} ) - ( {I}^{( 0 )} ( i , j ) ≫ {n}_{b} ) \qquad Eq . ( 19 )$$

where Ω can be a 6×6 window around the 4×4 subblock, and the values of nₐ and n_{b} can be set equal to min (1, −itDepth−11) and min (4, −itDepth−8), respectively.

The motion refinement (vₓ, v_{y}) can then be derived using the cross- and auto-correlation terms using Eqs. (20) and (21) as follows:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad Eq . ( 20 )$$

$${v}_{y} = {S}_{5} > \text{} 0 ? clip 3 \text{} ( - {th}_{BIO}^{′} , \text{} {th}_{BIO}^{′} , \text{} - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 s} ) \text{} / 2 ) ≫ \text{} ⌊ {log}_{2} {S}_{5} ⌋ ) ) : 0 \qquad Eq . ( 21 )$$

where

$${S}_{2 , m} = {S}_{2} ≫ {n}_{{S}_{2}} , {s}_{2 , s} = {S}_{2} \& ( {2}^{{n}_{{s}_{2}}} - 1 ) , {th}_{BIO}^{′} = {2}^{max ( 5 , BD - 7 )} .$$

└⋅┘ is a floor function, and nₛ_{₂}=12. Based on the motion refinement and the gradients, an adjustment can be calculated for each sample in the 4×4 subblock based on Eq. (22):

$$b ( x , y ) = rnd \text{} \text{} ( \text{} ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) \text{} / \text{} 2 ) \qquad Eq . ( 22 )$$

Finally, the BDOF samples of the CU can be calculated by adjusting the bi-prediction samples in Eq. (23) as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad Eq . ( 23 )$$

Values can be selected such that multipliers in the BDOF process do not exceed 15-bits, and a maximum bit-width of the intermediate parameters in the BDOF process can be kept within 32-bits.

FIG. 15 shows a diagram illustrating some calculations in a bi-directional optical flow (BDOF) in an example. In order to derive the gradient values, some prediction samples I^{(k)}(i,j) in the list k (k=0,1) outside of the current CU boundaries need to be generated. As shown in FIG. 15, BDOF in VVC can use one extended row/column (1502) around boundaries (1506) of a CU (1504). In order to control the computational complexity of generating the out-of-boundary prediction samples, prediction samples in an extended area (e.g., unshaded region in FIG. 15) can be generated by taking the reference samples at the nearby integer positions (e.g., using a floor( ) operation on the coordinates) directly without interpolation, and a normal 8-tap motion compensation interpolation filter can be used to generate prediction samples within the CU (e.g., the shaded region in FIG. 15). The extended sample values can be used in gradient calculation only. For the remaining steps in the BDOF process, if any samples and gradient values outside of the CU boundaries are needed, the samples and gradient values can be padded (e.g., repeated) from nearest neighbors of the samples and gradient values.

In some examples, sample based BDOF can be used instead of a block based BDOF. In the sample-based BDOF, instead of deriving motion refinement (vₓ, v_{y}) on a block basis, it is performed per sample. The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive vₓ and v_{y}. The derived motion refinement (vₓ, v_{y}) is applied to adjust the bi-predicted sample value for the center sample of the window.

In some examples, multi-pass DMVR can be used. In an example, in the first pass, bilateral matching (BM) is applied to a coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

Specifically, the first pass performs block based bilateral matching MV refinement. In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1. The bilateral matching cost can be calculated by any suitable error measuring metric that measures errors between the two reference blocks in L0 and L1. In an example, the bilateral matchIst includes a term that is a sum of absolute differences (SAD) between corresponding samples in the two reference blocks in L0 and L1.

BM can perform local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW×cbH is greater than 64, a mean removed SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV0\_pass1 = MV 0 + deltaMV \qquad Eq . ( 24 )$$

$$MV1\_pass1 = MV 1 - deltaMV \qquad Eq . ( 25 )$$

In the second pass, subblock based bilateral matching MV refinement is performed. Specifically, in the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated by applying a cost factor to the sum of absolute transformed differences (SATD) cost between two reference subblocks, as: bilCost=satdCost×costFactor. In some examples, the search area (2×sHor+1)×(2×sVer+1) is divided up to 5 diamond shape search regions.

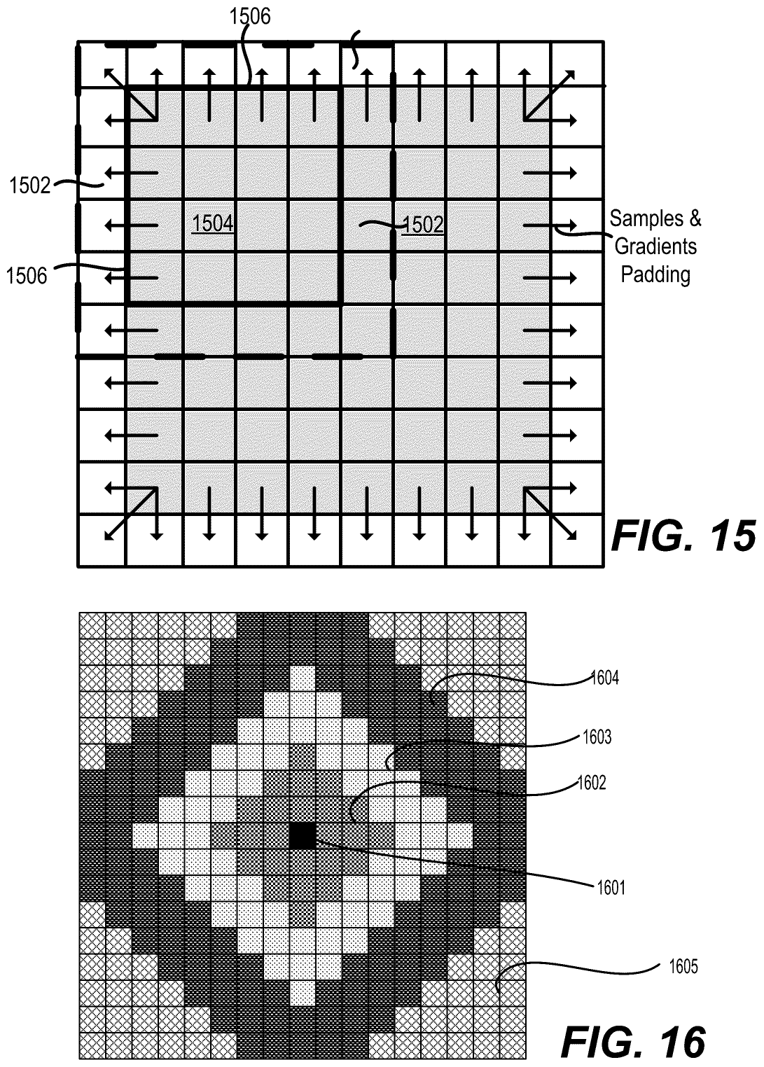

FIG. 16 shows a search area (1600) in some examples. The search area (1600) is divided to 5 search regions (1601)-(1605). The shape of the search regions is similar to diamond shape.

In some examples, each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW×sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

In some examples, the fractional sample refinement, such as the DMVR fractional sample refinement in VVC, is further applied to derive the final deltaMV(sbIdx2). The refined MVs at second pass is then derived as:

$$MV0\_pass2 ( sbIdx 2 ) = MV0\_pass1 + deltaMV ( sbIdx 2 ) \qquad Eq . ( 26 )$$

$$MV1\_pass2 ( sbIdx 2 ) = MV1\_pass1 + deltaMV ( sbIdx 2 ) \qquad Eq . ( 27 )$$

In the third pass, subblock based bi-directional optical flow MV refinement can be performed. Specifically, in the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv(Vx, Vy) is rounded to 1/16 sample precision and clipped between −32 and 32. The refined MVs (MV0_pass3(sbIdx3) and MV1_pass3(sbIdx3)) at third pass are derived as:

$$MV0\_pass3 ( sbIdx 3 ) = MV0\_pass2 ( sbIdx 2 ) + bioMv \qquad Eq . ( 28 )$$

$$MV1\_pass3 ( sbIdx 3 ) = MV0\_pass2 ( sbIdx 2 ) + bioMv \qquad Eq . ( 29 )$$

In some examples, a technique that is referred to as high-precision MV refinement for BDOF is used. In some examples, BDOF sample adjustment can derive a motion refinement (vx, vy) for a 4×4 subblock and adjust samples individually. In some examples (e.g., ECM), two kinds of BDOFs can be used, they are BDOF as MV refinement (3^{rd} stage of DMVR process), and BDOF as sample adjustment (similar to VVC, but derives motion adjustment (vx, vy) for each sample separately).

In some examples, the high-precision equations are used to derive the BDOF MV refinement parameters, such as Eq. (30) and Eq. (31):

$$\sum Gx \cdot Gx * vx + \sum Gx \cdot Gy * vy = \sum dI \cdot Gx \to s 1 * vx + s 2 * vy = s 3 \qquad Eq . ( 30 )$$

$$\sum Gx \cdot Gy * vx + \sum Gy \cdot Gy * vy = \sum dI \cdot Gy \to s 2 * vx + s 5 * vy = s 6 \qquad Eq . ( 31 )$$

where Gx/Gy are the summation of the 2 horizontal/vertical gradients derived for each reference block. Summations (Σ) are weighted sums, where weights depend on the position in the target region Ω. The weights can also be applied to derive vx/vy in other cases.

Also, subblock size of BDOF DMVR is adaptively selected depending on the width×height. For blocks smaller than 256, subblock size of 4×4, and otherwise 8×8 is used.

It is noted that, in some related examples, the 8×8 size BDOF is applied for GPM with bi-predictive motion vector. However, the BDOF applied along the GPM partition boundary may cause visual artifact.

Some aspects of the disclosure provide techniques to apply variable BDOF subblock size and adaptive switch of BDOF on/off for the GPM partition which has bi-predictive motion vector. For example, encoder/decoder can determine, for a current block in a current picture, a geometric partition mode (GPM) with at least a first GPM partition having a bi-predictive motion vector. Encoder/decoder can apply subblock based motion refinements with bi-directional motion on at least a first subblock and a second subblock of the first GPM partition. The first subblock and the second subblock have different subblock sizes. The current block can be reconstructed based on the subblock based motion refinements.

In some embodiments, the coded block of each GPM partition is split into N×N subblock, where N is positive number, and is larger than or equal to the largest supported BDOF subblock size (e.g., width or height for a square shape subblock) of the coded block (e.g., also referred to as coding block, current block). In an example, the BDOF subblock size is determined at each N×N subblock level based on values of a blending mask in the N×N subblock.

In some examples, the supported BDOF subblock size could be different depends on the size of coded block. In an example, the supported largest (also referred to as largest supported) BDOF subblock can be different based on the size of the coded block.

In some examples, the BDOF subblock size is determined by the corresponding mask value (e.g., values of the blending mask) in the N×N subblock. Thus, in some examples, the BDOF subblock size can be variable within the coding block, and the subblock size can depend on which sub partition the subblock belongs to and/or whether it is located at the partitioning boundary.

In some examples, BDOF subblock size is equal to the supported largest BDOF subblock size when all mask values (of the blending mask) within the N×N subblock are maximum weight value or minimum weight value.

In some examples, BDOF subblock size can be further split into smaller subblock size, e.g., (N/2)×(N/2), when all mask values within the N×N subblock are not the maximum weight value and N/2 is larger than or equals to the supported minimum BDOF subblock size.

In some examples, BDOF subblock size can be further split into smaller subblock size, e.g., (N/2)×(N/2), when all mask values within the N×N subblock are not the minimum weight value and N/2 is larger than or equals to the supported minimum BDOF subblock size.

In some examples, BDOF subblock size can be further split into smaller subblock size, e.g., (N/2)×(N/2), when all mask values within the N×N subblock are not the maximum or minimum weight value and N/2 is larger than or equals to the supported minimum BDOF subblock size.

In some examples, the BDOF subblock size can be recursively split into the smaller subblock when the split subblock size is larger than the supported minimum BDOF subblock size.

In some examples, the corresponding mask value in the n×n subblock is used to determine whether the BDOF is applied or not at that n×n subblock. And the n could be N, (N/2), (N/4), and the like.

In an example, when all mask values within the n×n subblock are the maximum (or minimum) weight value, for example, 32 (e.g., in ECM), the BDOF is applied on that n×n subblock.

In an example, when all mask values within the n×n subblock are not zero, the BDOF is applied on that n×n subblock.

In an example, when all mask values within the n×n subblock are larger than and (or) equal to a predefined threshold value T, the BDOF is applied on that n×n subblock. The predefined threshold value T could be a fixed predefined value or be signaled in high level syntax including but not limited to SPS, PPS, PH, slice header, . . . , etc.

In an example, when all mask values within the n×n subblock are greater than or equal to a given threshold, the BDOF will be applied on that n×n subblock. Example mask value includes the maximum weight value, or the maximum weight value minus a pre-defined offset value.

In an example, when all mask values within the n×n subblock are less than or equal to a given threshold, the BDOF will be applied on that n×n subblock. Example mask value includes 0, or a pre-defined positive offset value.

Some aspects of the disclosure provide techniques to determine the DMVR subblock size and whether the DMVR is applied or not for the GPM partition which has bi-predictive motion vector.

In some examples, the coded block of each GPM partition is split into w×h subblocks, and the corresponding mask value in each w×h subblock is used to determine whether the DMVR is applied or not at that w×h subblock.

In an example, the supported DMVR subblock size can be different depends on the size of coded block.

In some examples, the corresponding mask values of the blending mask in the w×h subblock are used to determine whether the DMVR is applied or not at that w×h subblock.

In an example, when all mask values within the n×n subblock are the maximum weight value, for example, 32 (e.g., in ECM), the DMVR will be applied on that w×h subblock. Otherwise, DMVR will not be applied on that w×h subblock.

In some examples, the multi-pass DMVR, including but not limited to the first pass DMVR, the second pass DMVR, and BDOF MV refinement, can be applied when DMVR is determined to be applied at that w×h subblock.

In some examples, whether a multi-pass DMVR is applied on top of a GPM partition that have bi-predictive MVs can be determined depending on the GPM split mode index. In an example, multi-pass DMVR is applied when the GPM angle is horizontal or vertical.

In some examples, whether a subblock contains the GPM partitioning boundary (e.g., the GPM partitioning boundary cross the subblock) is first checked. If a subblock does not contain the GPM partitioning boundary, subblock-based DMVR and/or BDOF are/is applied to the partition that have bi-predictive MVs; otherwise, when a subblock contains the GPM partitioning boundary, both subblock-based DMVR and BDOF are disabled to avoid visual artifacts.

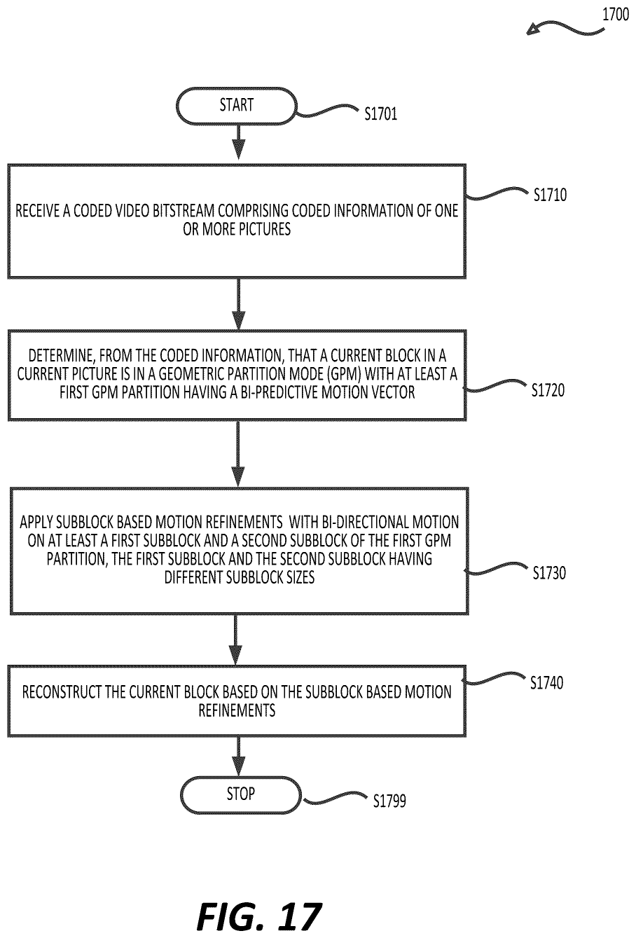

FIG. 17 shows a flow chart outlining a process (1700) according to an embodiment of the disclosure. The process (1700) can be used in a video decoder. In various embodiments, the process (1700) is executed by processing circuitry, such as the processing circuitry that performs functions of the video decoder (110), the processing circuitry that performs functions of the video decoder (210), and the like. In some embodiments, the process (1700) is implemented in software instructions, thus when the processing circuitry executes the software instructions, the processing circuitry performs the process (1700). The process starts at (51701) and proceeds to (S1710).

At (S1710), a coded video bitstream including coded information of one or more pictures is received.

At (S1720), from the coded information, a current block in a current picture is in a geometric partition mode (GPM) with at least a first GPM partition having a bi-predictive motion vector is determined.

At (S1730), subblock based motion refinements with bi-directional motion are applied on at least a first subblock and a second subblock of the first GPM partition, the first subblock and the second subblock have different subblock sizes.

At (S1740), the current block is reconstructed based on the subblock based motion refinements.

In some examples, the subblock based motion refinements are bi-directional optical flow (BDOF) motion refinements, the first subblock is a first BDOF subblock, and the second subblock is a second BDOF subblock.

In some examples, the first GPM partition is divided into larger subblocks of a N×N size, N is a positive number and the N×N size is larger than or equal to a largest supported BDOF subblock size. Respective BDOF subblock sizes are determined for the larger subblocks of the N×N size. The larger subblocks are divided into BDOF subblocks based on the respective BDOF subblock sizes. The BDOF motion refinements are applied on the BDOF subblocks.

In some examples, a supported BDOF subblock size is determined based on a size of the current block.

In some examples, a first BDOF subblock size is determined for a first larger subblock of the N×N size according to values of a blending mask in the first larger subblock. The first larger subblock is divided into first BDOF subblocks according to the first BDOF subblock size. The BDOF motion refinements are applied on the first BDOF subblocks.

In an example, the first BDOF subblock size is set to be the largest supported BDOF subblock size when all of mask values in the first larger subblock correspond a maximum weight value or correspond to a minimum weight value. In another example, the first BDOF subblock size is set to be smaller than the largest supported BDOF subblock size and larger or equal to a minimum supported BDOF subblock size when none of the mask values in the first larger subblock correspond to the maximum weight value. In another example, the first BDOF subblock size is set to be smaller than the largest supported BDOF subblock size and larger or equal to the minimum supported BDOF subblock size when none of the mask values in the first larger subblock correspond to the minimum weight value. In another example, the first BDOF subblock size is set to be smaller than the largest supported BDOF subblock size and larger or equal to the minimum supported BDOF subblock size when none of the mask values in the first larger subblock correspond to the maximum weight value or the minimum weight value.

In some examples, whether to apply a BDOF refinement on at least a portion of the first larger subblock is determined based on a mask value in the portion of the first larger subblock. In an example, to apply the BDOF refinement on the portion of the first larger subblock is determined when all of mask values in the portion of the first larger subblock correspond a maximum weight value or correspond to a minimum weight value. In another example, to apply the BDOF refinement on the portion of the first larger subblock is determined when none of the mask values in the portion of the first larger subblock are zero. In another example, to apply the BDOF refinement on the portion of the first larger subblock is determined when all of the mask values in the portion of the first larger subblock are higher than a threshold. In another example, to apply the BDOF refinement on the portion of the first larger subblock is determined when all of the mask values in the portion of the first larger subblock are smaller than a threshold.

In some examples, the subblock based motion refinements are decoder side motion vector refinement (DMVR) refinements, the first subblock is a first DMVR subblock, and the second subblock is a second DMVR subblock.

In an example, the first GPM partition is divided into a plurality of subblocks, and whether to apply a DMVR refinement on a specific subblock is determined based on mask values of a blending mask in the specific subblock.

In some examples, a supported DMVR subblock size is determined based on a size of the current block.

In an example, to apply the DMVR refinement on the specific subblock is determined when all of the mask values in the specific subblock correspond a maximum weight value or correspond to a minimum weight value.

In an example, a multi-pass DMVR is applied on the specific subblock when the DMVR refinement is determined to be applied on the specific subblock.

In an example, to apply the multi-pass DMVR is determined based on a GPM split mode index.

In an example, to apply the multi-pass DMVR when a GPM angle is one of horizontal and/or vertical.

In an example, whether a GPM partitioning boundary crosses a specific subblock is checked. A subblock based motion refinement with bi-directional motion is applied on the specific subblock when the GPM partitioning boundary does not cross the specific subblock. The subblock based motion refinement for the specific subblock is disabled when the GPM partitioning boundary crosses the specific subblock.

Then, the process proceeds to (S1799) and terminates.

The process (1700) can be suitably adapted. Step(s) in the process (1700) can be modified and/or omitted. Additional step(s) can be added. Any suitable order of implementation can be used.

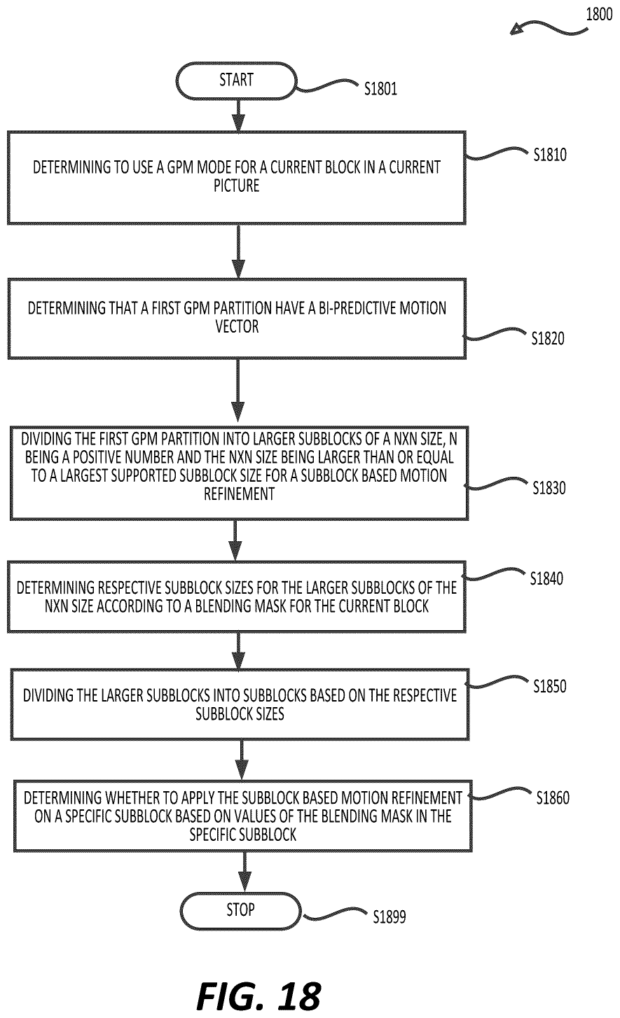

FIG. 18 shows a flow chart outlining a process (1800) according to an embodiment of the disclosure. The process (1800) can be used in a video encoder. In various embodiments, the process (1800) is executed by processing circuitry, such as the processing circuitry that performs functions of the video encoder (103), the processing circuitry that performs functions of the video encoder (303), and the like. In some embodiments, the process (1800) is implemented in software instructions, thus when the processing circuitry executes the software instructions, the processing circuitry performs the process (1800). The process starts at (51801) and proceeds to (S1810).

At (S1810), to use a GPM mode for a current block in a current picture is determined.

At (S1820), a first GPM partition having a bi-predictive motion vector is determined.

At (S1830), the first GPM partition is divided into larger subblocks of a N×N size, N is a positive number and the N×N size is larger than or equal to a largest supported subblock size for a subblock based motion refinement.

At (S1840), respective subblock sizes for the larger subblocks of the N×N size are determined according to a blending mask for the current block.

At (S1850), the larger subblocks are divided into subblocks based on the respective subblock sizes.

At (S1860), whether to apply the subblock based motion refinement on a specific subblock is determined based on values of the blending mask in the specific subblock.

In some examples, the subblock based motion refinement is bi-directional optical flow (BDOF) motion refinement.

In some examples, the subblock based motion refinement is decoder side motion vector refinement (DMVR) refinements.

Then, the process proceeds to (S1899) and terminates.

The process (1800) can be suitably adapted. Step(s) in the process (1800) can be modified and/or omitted. Additional step(s) can be added. Any suitable order of implementation can be used.

Some aspects of the disclosure provide a method of processing visual media data. The method includes processing a bitstream of visual media data according to a format rule. The bitstream includes coded information of one or more pictures that indicate a current block in a current picture is coded in a geometric partition mode (GPM) mode with at least a first GPM partition having a bi-predictive motion vector. The format rule specifies that the current block is split into GPM partitions according to the GPM mode, a first GPM partition of GPM partition has a bi-predictive motion vector, and the first GPM partition is divided into larger subblocks of a N×N size. N is a positive number and the N×N size is larger than or equal to a largest supported subblock size for a subblock based motion refinement. The format rule also specifies that respective subblock sizes for the larger subblocks of the N×N size are determined according to a blending mask for the current block, the larger subblocks are divided into subblocks based on the respective subblock sizes, and the subblock based motion refinement on a specific subblock is applied based on values of the blending mask in the specific subblock. The subblock based motion refinement is one of a bi-directional optical flow (BDOF) motion refinement and a decoder side motion vector refinement (DMVR) refinement.

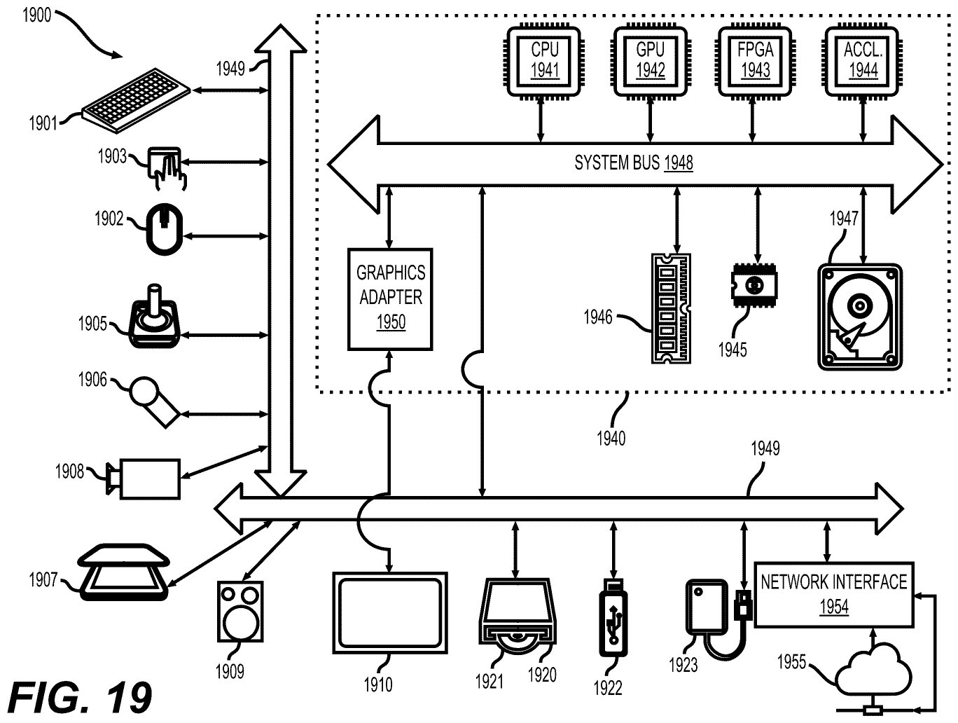

The techniques described above, can be implemented as computer software using computer-readable instructions and physically stored in one or more computer-readable media. For example, FIG. 19 shows a computer system (1900) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 19 for computer system (1900) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (1900).

Computer system (1900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1901), mouse (1902), trackpad (1903), touch screen (1910), data-glove (not shown), joystick (1905), microphone (1906), scanner (1907), camera (1908).

Computer system (1900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1910), data-glove (not shown), or joystick (1905), but there can also be tactile feedback devices that do not serve as input devices), audio output devices (such as: speakers (1909), headphones (not depicted)), visual output devices (such as screens (1910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1900) can also include human accessible storage devices and their associated media such as optical media including CD/DVD ROM/RW (1920) with CD/DVD or the like media (1921), thumb-drive (1922), removable hard drive or solid state drive (1923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1900) can also include an interface (1954) to one or more communication networks (1955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1949) (such as, for example USB ports of the computer system (1900)); others are commonly integrated into the core of the computer system (1900) by attachment to a system bus as described below (for example Ethernet interface into a PC computer system or cellular network interface into a smartphone computer system). Using any of these networks, computer system (1900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1940) of the computer system (1900).

The core (1940) can include one or more Central Processing Units (CPU) (1941), Graphics Processing Units (GPU) (1942), specialized programmable processing units in the form of Field Programmable Gate Areas (FPGA) (1943), hardware accelerators for certain tasks (1944), graphics adapters (1950), and so forth. These devices, along with Read-only memory (ROM) (1945), Random-access memory (1946), internal mass storage such as internal non-user accessible hard drives, SSDs, and the like (1947), may be connected through a system bus (1948). In some computer systems, the system bus (1948) can be accessible in the form of one or more physical plugs to enable extensions by additional CPUs, GPU, and the like. The peripheral devices can be attached either directly to the core's system bus (1948), or through a peripheral bus (1949). In an example, the screen (1910) can be connected to the graphics adapter (1950). Architectures for a peripheral bus include PCI, USB, and the like.

CPUs (1941), GPUs (1942), FPGAs (1943), and accelerators (1944) can execute certain instructions that, in combination, can make up the aforementioned computer code. That computer code can be stored in ROM (1945) or RAM (1946). Transitional data can also be stored in RAM (1946), whereas permanent data can be stored for example, in the internal mass storage (1947). Fast storage and retrieve to any of the memory devices can be enabled through the use of cache memory, that can be closely associated with one or more CPU (1941), GPU (1942), mass storage (1947), ROM (1945), RAM (1946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1900), and specifically the core (1940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1940) that are of non-transitory nature, such as core-internal mass storage (1947) or ROM (1945). The software implementing various embodiments of the present disclosure can be stored in such devices and executed by core (1940). A computer-readable medium can include one or more memory devices or chips, according to particular needs. The software can cause the core (1940) and specifically the processors therein (including CPU, GPU, FPGA, and the like) to execute particular processes or particular parts of particular processes described herein, including defining data structures stored in RAM (1946) and modifying such data structures according to the processes defined by the software. In addition or as an alternative, the computer system can provide functionality as a result of logic hardwired or otherwise embodied in a circuit (for example: accelerator (1944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding, comprising:
receiving a coded video bitstream comprising coded information of one or more pictures;
determining, from the coded information, that a current block in a current picture is coded in a geometric partition mode (GPM) with at least a first GPM partition having a bi-predictive motion vector;
applying subblock based motion refinements with bi-directional motion on at least a first subblock and a second subblock of the first GPM partition, the first subblock and the second subblock having different subblock sizes; and
reconstructing the current block based on the subblock based motion refinements.

2. The method of claim 1, wherein the subblock based motion refinements are bi-directional optical flow (BDOF) motion refinements, the first subblock is a first BDOF subblock, and the second subblock is a second BDOF subblock.

3. The method of claim 2, wherein the applying comprises:
dividing the first GPM partition into larger subblocks of a N×N size, N being a positive number and the N×N size being larger than or equal to a largest supported BDOF subblock size;
determining respective BDOF subblock sizes for the larger subblocks of the N×N size;
dividing the larger subblocks into BDOF subblocks based on the respective BDOF subblock sizes; and
applying the BDOF motion refinements on the BDOF subblocks.

4. The method of claim 1, further comprising:
determining a supported BDOF subblock size based on a size of the current block.

5. The method of claim 3, wherein the applying comprises:
determining a first BDOF subblock size for a first larger subblock of the N×N size according to values of a blending mask in the first larger subblock;
dividing the first larger subblock into first BDOF subblocks according to the first BDOF subblock size; and
applying the BDOF motion refinements on the first BDOF subblocks.

6. The method of claim 5, further comprising at least one of:
setting the first BDOF subblock size to be the largest supported BDOF subblock size when all of mask values in the first larger subblock correspond a maximum weight value or correspond to a minimum weight value;
setting the first BDOF subblock size to be smaller than the largest supported BDOF subblock size and larger or equal to a minimum supported BDOF subblock size when none of the mask values in the first larger subblock correspond to the maximum weight value;
setting the first BDOF subblock size to be smaller than the largest supported BDOF subblock size and larger or equal to the minimum supported BDOF subblock size when none of the mask values in the first larger subblock correspond to the minimum weight value; and/or
setting the first BDOF subblock size to be smaller than the largest supported BDOF subblock size and larger or equal to the minimum supported BDOF subblock size when none of the mask values in the first larger subblock correspond to the maximum weight value or the minimum weight value.

7. The method of claim 5, further comprising:
determining whether to apply a BDOF refinement on at least a portion of the first larger subblock based on a mask value in the portion of the first larger subblock.

8. The method of claim 7, wherein the determining whether to apply the BDOF refinement comprises:
determining to apply the BDOF refinement on the portion of the first larger subblock when all of mask values in the portion of the first larger subblock correspond a maximum weight value or correspond to a minimum weight value;
determining to apply the BDOF refinement on the portion of the first larger subblock when none of the mask values in the portion of the first larger subblock are zero;
determining to apply the BDOF refinement on the portion of the first larger subblock when all of the mask values in the portion of the first larger subblock are higher than a threshold; and
determining to apply the BDOF refinement on the portion of the first larger subblock when all of the mask values in the portion of the first larger subblock are smaller than a threshold.

9. The method of claim 1, wherein the subblock based motion refinements are decoder side motion vector refinement (DMVR) refinements, the first subblock is a first DMVR subblock, and the second subblock is a second DMVR subblock.

10. The method of claim 9, wherein the applying comprises:
dividing the first GPM partition into a plurality of subblocks; and
determining whether to apply a DMVR refinement on a specific subblock based on mask values of a blending mask in the specific subblock.

11. The method of claim 9, further comprising:
determining a supported DMVR subblock size based on a size of the current block.

12. The method of claim 10, further comprising:
determining to apply the DMVR refinement on the specific subblock when all of the mask values in the specific subblock correspond a maximum weight value or correspond to a minimum weight value.

13. The method of claim 10, further comprising:
applying a multi-pass DMVR on the specific subblock when the DMVR refinement is determined to be applied on the specific subblock.

14. The method of claim 13, further comprising:
determining to apply the multi-pass DMVR based on a GPM split mode index.

15. The method of claim 13, further comprising:
determining to apply the multi-pass DMVR when a GPM angle is one of horizontal or vertical.

16. The method of claim 1, wherein the applying comprises:
checking whether a GPM partitioning boundary crosses a specific subblock;
applying a subblock based motion refinement with bi-directional motion on the specific subblock when the GPM partitioning boundary does not cross the specific subblock; and
disabling the subblock based motion refinement for the specific subblock when the GPM partitioning boundary crosses the specific subblock.

17. A method for video encoding, comprising:
determining to use a geometric partition mode (GPM) for a current block in a current picture;
determining that a first GPM partition has a bi-predictive motion vector;
applying subblock based motion refinements with bi-directional motion on at least a first subblock and a second subblock of the first GPM partition, the first subblock and the second subblock having different subblock sizes; and
encoding the current block based on the subblock based motion refinements.

18. The method of claim 17, wherein the subblock based motion refinements are bi-directional optical flow (BDOF) motion refinements, the first subblock is a first BDOF subblock, and the second subblock is a second BDOF subblock.

19. The method of claim 18, wherein the applying comprises:
dividing the first GPM partition into larger subblocks of a N×N size, N being a positive number and the N×N size being larger than or equal to a largest supported subblock size for a subblock based motion refinement;
determining respective subblock sizes for the larger subblocks of the N×N size according to a blending mask for the current block;
dividing the larger subblocks into subblocks based on the respective subblock sizes; and
determining whether to apply the subblock based motion refinement on a specific subblock based on values of the blending mask in the specific subblock.

20. A non-transitory computer readable medium storing a video media bitstream that is encoded by an encoding method, the encoding method comprising:
determining to use a geometric partition mode (GPM) for a current block in a current picture;
determining that a first GPM partition has a bi-predictive motion vector;
applying subblock based motion refinements with bi-directional motion on at least a first subblock and a second subblock of the first GPM partition, the first subblock and the second subblock having different subblock sizes; and
encoding the current block into encoded information in the video media bitstream based on the subblock based motion refinements.
